(19) United States
(12) Patent Application Publication
(10) Pub. No.: US 2007/0020416 A1
(43) Pub. Date: Jan. 25, 2007

(54) Blow molded hollow articles and bottles made from trivalent cation neutralized ionomers

(76) Inventor: David M. Dean, West Chester, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/188,201

(22) Filed: Jul. 22, 2005

(51) Int. Cl. B32B 27/08

(52) U.S. Cl. 428/35.7; 264/532; 264/537; 264/540

(57) ABSTRACT

Disclosed are extrusion or injection molded hollow articles and blow molded bottles comprising ionomer neutralized with trivalent cations. These ionomers have higher melt strength than ionomer composition containing the same copolymer but neutralized only with mono- or divalent cations. The blow molded bottles can have wall thicknesses and weights substantially higher than those comprising ionomer neutralized only with mono- and divalent cations.

### BACKGROUND OF THE INVENTION

1. Field of the Invention

This invention relates to extrusion or injection molded hollow articles and to blow molded bottles comprising trivalent cation-neutralized ethylene-based ionomers.

2. Description of the Related Art

Generally, in the production of blow molded bottles and other hollow articles a bottomed preform is prepared by extrusion or injection molding, and then the preform is blown to the desired shape and size. Consequently, the preform must maintain its integrity and shape during the process. Particularly in extrusion molding processes polymeric resins must have sufficiently low melt viscosity under the high shear conditions of the extruder in order to have acceptable processibility and achieve throughputs necessary for commercial operation. At the same time, the resins must have sufficient melt strength after extrusion to prevent sagging and distortion of the extrudate before the blowing process and before the resin is cooled below its melting point. As the wall thickness of the bottles or hollow articles become greater, or as their size (and weights) become larger, the requirement for high melt strength at acceptable viscosities becomes greater also.

Ethylene-based ionomers have been used for blow molding because of their improved melt strength at workable melt viscosities. lonomers are copolymers containing ionizable comonomers that are at least partially neutralized (ionized) to yield salts. Normally they are prepared by copolymerization of ethylene with small amounts of an unsaturated carboxylic acid, followed by neutralization of some portion of the acid groups. The ionized groups can act as meltable crosslinks. In conventional ionomers used for this purpose the carboxylic acid groups are neutralized by mono- and divalent cations such as Na⁺, Mg⁺², Zn⁺², and the like.

It has been found that even with the improved melt strength of the conventional ionomers, it is difficult to prepare bottles and hollow articles with wall thicknesses greater than about 1 mm. The present invention provides blow molded bottles and hollow articles with increased wall thicknesses made from ionomers comprising trivalent cation neutralized carboxyl groups.

Japanese Patent Publication No. 56-55442 discloses a resin composition comprising a copolymer of ethylene and α,β-ethylenically unsaturated carboxylic acid and optionally an α,β-unsaturated ester, partially or completely ionically crosslinked by ions, and a polyamide resin having a melting point of not more than 160° C. Ten percent or more of the α,β-unsaturated carboxylic acid component is disclosed to be neutralized by Na⁺, Mg⁺², Zn⁺², Al⁺³ and the like. The examples disclose only ionomers neutralized with magnesium, zinc and sodium ions.

U.S. Pat. No. 4,766,174 discloses melt processible blends of aluminum ionomers of ethylene/α,β-ethylenically unsaturated carboxylic acid copolymers and thermoplastic resins or elastomers. From about 1 to about 100% of the carboxylic acid groups of the ethylene copolymer are neutralized with aluminum ions.

### SUMMARY OF THE INVENTION

In one embodiment this invention is directed to an extrusion or injection molded hollow article suitable for use as a preform or parison for blow molding, and to a blow molded bottle, both comprising an ionomer composition that comprises at least one direct or graft copolymer of ethylene, α,β-ethylenically unsaturated carboxylic acid having from 3 to 8 carbon atoms, and softening comonomer selected from the group consisting of vinyl esters of aliphatic carboxylic acids wherein the acids have from 2 to 10 carbon atoms, alkyl vinyl ethers wherein the alkyl group contains from 1 to 10 carbon atoms, and alkyl acrylates or methacrylates wherein the alkyl group contains from 1 to 10 carbon atoms; wherein the unsaturated carboxylic acid content is from about 1 to about 25 weight percent, the softening comonomer content is from 0 to about 60 weight percent; the remainder being ethylene, such that the ethylene content is greater than about 30 weight percent; further wherein the acid groups derived from the α,β-ethylenically unsaturated carboxylic acid are from about 3 to about 80%, preferably from about 3 to about 60% and more preferably from about 3 to about 50%, neutralized with trivalent cations and from 0 to about 70% neutralized with mono- or divalent cations.

The invention also relates to the extrusion molded hollow article or blow molded bottle that is a multilayer device where at least one layer comprises the above ionomer composition.

Preferably, the ionomer composition is from about 3 to about 80%, more preferably about 3 to about 60% and most preferably from about 3 to about 50%, neutralized with trivalent cations and from about 1 to about 70% neutralized with mono- or divalent cations, and the melt strength of the ionomer composition is substantially greater than that of an ionomer composition containing the same copolymer but neutralized only with mono- or divalent cations. More preferably the melt strength of the ionomer composition is greater than about 20 cN when measured at 220° C.

The invention is also directed to a blow molding process for producing bottles from a polymer composition comprising the steps:

(a) extrusion or injection molding a closed-bottom hollow preform from the polymer composition at a temperature above the glass transition and melting temperature ranges of the bulk polymer composition;

(b) maintaining the preform at a blow molding temperature above the glass transition and melting temperature ranges of the bulk polymer composition;

(c) introducing compressed air or other gas into the preform so as to biaxially expand the preform outwardly against the walls of the blow mold to assume the desired configuration,

wherein the polymer composition comprises at least one direct or graft copolymer of ethylene, α,β-ethylenically unsaturated carboxylic acid having from 3 to 8 carbon atoms, and softening comonomer selected from the group consisting of vinyl esters of aliphatic carboxylic acids wherein the acids have from 2 to 10 carbon atoms, alkyl vinyl ethers wherein the alkyl group contains from 1 to 10 carbon atoms, and alkyl acrylates or methacrylates wherein the alkyl group contains from 1 to 10 carbon atoms; wherein the unsaturated carboxylic acid content is from about 1 to about 25 weight percent, the softening comonomer content is from 0 to about 60 weight percent; the remainder being ethylene, such that the ethylene content is greater than about 30 weight percent; further wherein the acid groups derived from the α,β-ethylenically unsaturated carboxylic acid are from about 3 to about 80%, preferably from about 3 to about 60% and more preferably from about 3 to about 50%, neutralized with trivalent cations, and from 0 to about 70% neutralized with mono- or divalent cations.

### DETAILED DESCRIPTION OF THE INVENTION

Applicants specifically incorporate the entire content of all cited references in this disclosure. Trademarks are shown in upper case. Unless stated otherwise, all percentages, parts, ratios, etc., are by weight. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When a component is indicated as present in a range starting from 0, such component is an optional component (i.e., it may or may not be present).

As used herein, the term “monomer” refers to a relatively simple compound, usually containing carbon and of low molecular weight, which can react to form a polymer by combining with like molecules or with other similar molecules or compounds. As used herein, the term “comonomer” refers to a monomer that is copolymerized with at least one different monomer in a copolymerization reaction, the result of which is a copolymer.

As used herein, the term “polymer” refers to the product of a polymerization reaction, and is inclusive of homopolymers, copolymers, terpolymers, tetrapolymers, etc. In general, the layers of a structure can consist essentially of a single polymer, or can have additional polymers together therewith, i.e., blended therewith.

As used herein, the term “homopolymer” is used with reference to a polymer resulting from the polymerization of a single monomer, i.e., a polymer consisting essentially of a single type of repeating unit.

As used herein, the term “copolymer” refers to polymers formed by the polymerization reaction of at least two different monomers. As used herein, the term “copolymerization” refers to the simultaneous polymerization of two or more monomers. The term “copolymer” is also inclusive of random copolymers, block copolymers, and graft copolymers.

As used herein, the term “polymerization” is inclusive of homo-polymerizations, copolymerizations, terpolymerizations, etc., and includes all types of copolymerizations such as random, graft, block, condensation, etc. In general, the polymers, in the structures used in accordance with the present invention, can be prepared in accordance with any suitable polymerization process, including slurry polymerization, gas phase polymerization, and high pressure polymerization processes.

As indicated above, a first embodiment of the invention is an extrusion or injection molded hollow article comprising an ionomer composition that comprises at least one direct or graft copolymer of ethylene, α,β-ethylenically unsaturated carboxylic acid having from 3 to 8 carbon atoms, and softening comonomer selected from the group consisting of vinyl esters of aliphatic carboxylic acids wherein the acids have from 2 to 10 carbon atoms, alkyl vinyl ethers wherein the alkyl group contains from 1 to 10 carbon atoms, and alkyl acrylates or methacrylates wherein the alkyl group contains from 1 to 10 carbon atoms; wherein the unsaturated carboxylic acid content is from about 1 to about 25 weight percent, the softening comonomer content is from 0 to about 60 weight percent; the remainder being ethylene, such that the ethylene content is greater than about 30 weight percent; further wherein the acid groups derived from the α,β-ethylenically unsaturated carboxylic acid are from about 3 to about 80% neutralized with trivalent cations and from 0 to about 70% neutralized with mono- or divalent cations.

As indicated above, the ionomer compositions of the invention comprise at least one direct or graft copolymer of ethylene, α,β-ethylenically unsaturated carboxylic acid, and optional softening comonomer selected from the group consisting of vinyl esters, alkyl vinyl ethers, and alkyl acrylates or methacrylates.

The direct or graft copolymers of ethylene and α,β-ethylenically unsaturated carboxylic acid and softening comonomer, if present, and methods for their preparation have been described in the art in, for example, U.S. Pat. Nos. 3,264,272 and 4,766,174, which are incorporated herein by reference.

The α,β-unsaturated carboxylic acid of the ionomer contains from 3 to 8 carbon atoms. Preferably the α,β-ethylenically unsaturated carboxylic acid of the copolymer is selected from the group consisting of acrylic acid, methacrylic acid, maleic acid, fumaric acid, itaconic acid, and half esters of maleic, fumaric and itaconic acids. More preferably the α,β-unsaturated carboxylic acid is acrylic or methacrylic acid, and still more preferably the acid is methacrylic acid.

The optional softening comonomer, when present, is selected from vinyl esters, alkyl vinyl ethers, and alkyl acrylates or methacrylates. Accordingly, suitable softening monomers are, for example, vinyl acetate, butyl vinyl ether, methyl vinyl ether, methyl acrylate, methyl methacrylate, ethyl acrylate, ethyl methacrylate, butyl acrylate and butyl methacrylate. Preferably the softening comonomer is alkyl acrylate, alkyl methacrylate or alkyl vinyl ether, and more preferably the softening comonomer is butyl acrylate.

The ethylene content of the ethylene/acid copolymer preferably is greater than about 50 weight percent, and more preferably greater than about 60 weight percent.

The ethylene/acid copolymer preferably contains from 0 to about 40 weight percent of softening comonomer. More preferably the copolymer contains from about 5 to about 15 weight percent of unsaturated carboxylic acid and from 0 to about 30 weight percent of softening monomer; the remainder being ethylene, such that the ethylene content is greater than about 60 weight percent.

In the ionomers of the present invention, from about 3 to about 80%, preferably from about 3 to about 60% and more preferably from about 3 to about 50%, of the carboxylic acid groups are neutralized with trivalent cations. Generally it is found that if the trivalent cation neutralization level exceeds about 80%, the ionomer composition becomes so viscous that it is difficult or even impossible to process.

In the context of this disclosure the percent neutralization data are presented using the assumption that each cation will react with the maximum number of carboxylic acid groups calculated from its ionic charge. That is, it is postulated for example, that Al⁺³ will react with three carboxylic acid groups, that Mg⁺² and Zn⁺² will react with two, and that Na⁺ will react with one.

The trivalent cation can be any positively charged ion capable of reacting with three carboxyl groups. Preferably the trivalent cations are selected from the group consisting of trivalent lanthanide metal cations, aluminum cation, chromium cation, and iron cation. The most preferred trivalent cation is aluminum cation. The source of trivalent cation may be any convenient derivative such as carboxylates, alkoxides, chelated compounds and hydroxides. In the case of aluminum cation the preferred sources are aluminum acetate, aluminum isopropoxide, aluminum acetylacetonate, and aluminum ethoxide.

In addition to neutralization with trivalent cations, some of the carboxylic acid groups of the ionomers optionally may be neutralized with mono- or divalent cations. Preferably monovalent cations, if present, are selected from the group consisting of sodium, potassium, and lithium, and divalent cations, if present, are selected from the group consisting of zinc, magnesium and calcium. More preferably the monovalent cation will be sodium, and the divalent cation will be zinc. Mono- and divalent ion sources are typically formates, acetates, hydroxides, nitrates, carbonates and bicarbonates. The number of carboxylic acid groups neutralized with mono- or divalent cations is preferably a maximum of about 70% of those acid groups present in the copolymer. A more preferable maximum is about 60% and most preferable maximum about 55%.

It is preferred that from about 20% to about 80% of the ionomer carboxylic acid groups be neutralized by the total of trivalent and optional monovalent and/or divalent cations. Generally the reaction of the ion sources with the carboxylic acid containing polymers is carried out by melt blending at temperatures in the range from about 150° to about 300° C.

The trivalent cation containing ionomers of the invention exhibit surprising properties. For example, for aluminum-containing ionomers the melt strength and melt viscosity are higher than and the sensitivity of melt viscosity to temperature is lower than ionomers based on the same copolymer but neutralized only with mono- or divalent cations. In addition, these same improved melt strength and melt viscosity properties are expected when the aluminum-containing ionomers are blended with other thermoplastic polymers. That is, the melt strength and melt viscosity are expected to be higher than and the sensitivity of melt viscosity to temperature lower than the same blends based on the same ionomer copolymer but neutralized only with mono- or divalent cations. Preferred thermoplastic polymers for blending with the trivalent cation containing ionomers are styrene-butadiene-styrene block copolymer, styrene-ethylene-butylene-styrene block copolymer, styrene-isoprene-styrene block copolymers, linear low density polyethylene, low density polyethylene, polypropylene and cyclic olefin copolymers.

Molded hollow articles suitable for use as a preform or parison for blow molding bottles can be prepared by injection or extrusion molding. Molding of preforms acceptable for later blow molding into container or bottle configurations requires the balancing of many factors. A detailed general reference to the foregoing brief discussion of these factors is contained in the Blow Molding Handbook, by Rosato and Rosato, Hanser Publishers, New York, N.Y., 1988, and particularly chapter 14 thereof.

Additional information regarding the injection molding of preforms is available in U.S. Pat. Nos. 5,914,138 and 6,596,213. U.S. Pat. No. 5,914,138 discloses a system and apparatus for injection molding articles of crystallizable polymeric materials in a substantially completely amorphous state. U.S. Pat. No. 6,596,213 describes techniques for molding multi-layer polymer plastic articles having inside, outside and interior or core layers by controlling relative volumetric flow rates of the inside and outside layers to enable relative shifting of the position of the core, and also the relative thickness of the inside and outside layers in the molded articles. The information in these patents is hereby incorporated herein by reference.

Typically, injection molding a bottle preform is conducted by transporting the molten materials of the various layers into a mold and allowing the molten materials to cool. The mold typically includes a first cavity extending inwardly from an outer surface of the mold to an inner end, an article formation cavity, and a gate connecting the first cavity to the article formation cavity. The gate defines an inlet orifice in the inner end of the first cavity, and an outlet orifice that opens into the article formation cavity. The article formation cavity typically may be cylindrical (but other profiles are contemplated) with an axially centered projection at the end opposite the gate. The molten materials flow through the gate into the cavity, filling the cavity. Thus, the molding will provide an article that is substantially a tube with an “open” end and a “closed” end encompassing a hollow volume. The open end will provide the neck of the bottle and the closed end will provide the base of the bottle after subsequent blow molding. The molding may be such that various flanges and protrusions at the open end provide strengthening ribs and/or closure means, for example screw threads, for a cap.

For a multilayer preform molding, the molten materials are injected into the mold from an annular die such that they form a laminar flow of concentric layers. Typically, the molten materials are introduced into the mold such that the material for the outside layer and the inside layer enter the mold cavity before the material for the interior layer enters and form a leading edge of the laminar flow through the cavity. For a period of time, the layers enter the mold cavity in a concentric laminar flow. Next, flow of the material for the interior layer is halted and the material for the outside and inside layers provides a trailing edge of the laminar flow. The flow continues until the entire cavity is filled and the trailing edge seals or fuses to itself at the gate area to form the closed end of the preform.

As noted above, positioning of the various layers in a cross-section of the preform can be adjusted by controlling relative volumetric flow rates of the inside and outside layers to enable relative shifting of the position of the core, and also the relative thickness of the inside and outside layers in the molded articles (see U.S. Pat. No. 6,596,213).

In extrusion molding of the hollow article or preform, the molten polymer (or polymers in the case of a multilayer structure) is extruded through a die or shaped orifice to form a hollow tubular structure. Since the extruded tubular structure, which is still above its glass transition and melting temperatures, is not supported in a mold before blow molding, high melt strength is required in order to avoid sagging and distortion of the structure before the blow molding step. For this reason preforms or bottles with walls or portions of wall thicker than about 1 mm require a high melt strength polymer in order to avoid sagging and distortion.

A representative process for blow molding a bottle from an injection or extrusion molded preform includes the steps of:

(a) injection or extrusion molding a closed-bottom hollow preform;

(b) in the case of injection molding reheating the preform to the blow molding temperature, or in the case of extrusion molding maintaining the preform at the blow molding temperature (normally at least 10° C. to 20° C. above the melting temperature of semi-crystalline resins of the bulk preform material); and

(c) introducing compressed air or other gas into the preform so as to biaxially expand the preform outwardly against the walls of the blow mold so that it assumes the desired configuration.

To prepare a bottle of this invention, the preform as described above is reheated and biaxially expanded by simultaneous axial stretching and blowing (as summarized above) in a shaped mold so that it assumes the desired configuration. Typically, the neck region is unaffected by the blow molding operation while the bottom and particularly the walls of the preform are stretched and thinned. Thus, it is important that the resulting thickness of the exterior layers and the interior layers provide sufficient strength and barrier properties to allow the bottle to contain and protect the product package within.

The bottles of the present invention can have wall thicknesses and weights substantially greater than bottles made from ionomer neutralized only with mono- and divalent cations. For example, the bottles of the invention can have wall thicknesses greater than about 1 mm and even as high as about 5 mm. These properties are difficult to achieve using ionomer neutralized only with mono- and divalent cations.

Although containers are generally described herein as bottles, other containers such as vials, jars, drums and fuel tanks may be prepared as described herein from the compositions and articles of this invention. Other articles, such as toys, panels, furniture and automotive parts may also be prepared similarly.

### EXAMPLES

In the following examples lonomer A was a copolymer of ethylene, 9 wt. % methacrylic acid and 23.5 wt. % n-butyl acrylate, with 51% of the methacrylic acid groups neutralized with Zn⁺² cations, and having a measured melt index (190° C./2.16 kg weight) of 0.6. lonomer B was a copolymer of ethylene and 10.5 wt. % methacrylic acid with 68% of the methacrylic acid groups neutralized with Zn⁺² cations, having a measured melt index (190° C./2.16 kg weight) of 1.1. lonomer C was a copolymer of ethylene and 15 wt. % methacrylic acid with 58% of the methacrylic acid groups neutralized with Zn⁺² cations, having a measured melt index (190° C./2.16 kg weight) of 0.7. The ionomers were prepared by procedures described in U.S. Pat. No. 3,264,272. Aluminum cations were introduced into the ionomers as aluminum acetylacetonate. The calculated values in the tables below for percent acid of the ionomer neutralized by Al⁺³ assume that all of the aluminum ions form trivalent salts with the ionomer carboxylic acid groups.

### Comparative Examples 1 and 2 and Examples 3-5

The formulations shown in Table 1 were compounded using a 30 mm BUSS-KNEADER extruder. Extruder zones from the feed to the die were set at temperatures of 130° C., 140° C., 145° C., and 150° C. respectively. The temperatures of the cross-head and die were set at 165° C. The materials were compounded at 5 pounds/hour and 150 RPM. The components were premixed by tumble mixing ingredients in a polyethylene bag and were then fed to the BUSS-KNEADER extruder.

Temperatures of the melt streams exiting the extruder were measured with a handheld thermocouple and were in the range of from 180 to 200° C. The calculated percent of methacrylic acid that was neutralized by the aluminum cations is given in Table 1.

TABLE 1

| | Comparative | Comparative | | | |
|---|---|---|---|---|---|
| Material | Example 1 | Example 2 | Example 3 | Example 4 | Example 5 |
| Ionomer A (weight %) | 100 | 0 | 99.32 | 98.64 | 97.99 |
| Ionomer B(weight %) | 0 | 100 | 0.00 | 0.00 | 0.00 |
| Aluminum | 0 | 0 | 0.68 | 1.36 | 2.01 |
| Acetylacetonate | | | | | |
| (weight %) | | | | | |
| Calculated % Acid of | — | — | 6% | 12% | 18% |
| Ionomer | | | | | |
| Neutralized by Al⁺³ | | | | | |

Viscosity data were acquired using a KAYENESS GALAXY 5 CAPILLARY RHEOMETER. The cylindrical capillary die had dimensions of 30 mm long with a diameter of 1 mm (L/D=30). A pre-heat dwell time of 5 minutes was used before beginning the viscosity test. The apparent viscosities for the samples at various temperatures were obtained after drying the materials at 50° C. for 18 hours, per ASTM D3835, and are reported in Tables 2 and 3. At higher shear rates, certain compounds overpressured the rheometer and viscosity data could not be acquired. These points are noted as ND (No Data) in the following Tables.

TABLE 2
Apparent Viscosity (Pascal seconds) as Function of Shear Rate at 220° C.

| Apparent Shear | Comp. | Comp. | | | |
|---|---|---|---|---|---|
| Rate (s⁻¹) | Ex. 1 | Ex. 2 | Ex. 3 | Ex. 4 | Ex. 5 |
| 316.20 | 398.4 | 518 | 769.7 | 1020.6 | 1249 |
| 7.3 | 3109 | 2869.6 | 3937.8 | 6361 | 7429.2 |
| 12.2 | 2478 | 2534.8 | 3759.2 | 4438.4 | 5366.2 |
| 24.3 | 1492 | 1587.9 | 2635.3 | 3328.8 | 4022.3 |
| 36.5 | 1043 | 1307.3 | 2263.8 | 2796.3 | 3395.7 |
| 73.0 | 757.3 | 964.5 | 2059.8 | 2027.9 | 2448.8 |
| 97.3 | 666 | 847.7 | 1480.3 | 1825.8 | 2249.1 |
| 145.9 | 562 | 713.4 | 1197.3 | 1512.9 | 1878 |
| 316.2 | 396.2 | 509.2 | 825.6 | 1057.4 | 1307.5 |
| 681.0 | 274.7 | 346.7 | 557.9 | 716.4 | 867.2 |
| 1447.2 | 184.6 | 230.9 | 362 | 475.9 | 541.2 |
| 1994.5 | 156.5 | 194.1 | 301.7 | 390.1 | ND |
| 3089.0 | ND | 152.3 | 229.2 | ND | ND |

The data of Table 2 demonstrate that as the acid comonomers of the ethylene-methacrylic acid ionomer are further neutralized with aluminum cations, the viscosity quickly increases. For example, at a shear rate of 24.3 s⁻¹ and a temperature of 220° C., the increase in viscosity accomplished by neutralizing an additional 18% of the acid comonomer (Example 5) relative to the original ionomer material (Comparative Example 1) is 170%.

Table 3 presents viscosity data obtained from the ionomers of Comparative Example 1 and Example 5 as a function of temperature. The benefit provided by introducing the aluminum component can be seen when comparing the low temperature data (200° C.) to the high temperature data (230° C.) for a given shear rate. In addition to dramatically increasing viscosity, the introduction of the trivalent aluminum provides a material that has a melt viscosity that is less sensitive to temperature changes at lower shear rates. For example, by decreasing temperature from 230° C. to 200° C. at a shear rate of 24.3 s⁻¹, Comparative Example 1 has a change in viscosity of 82% (2501.4/1377.4); however, Example 3 only shows a change of 38% in viscosity between these two temperature extremes (4443.2/3218.8).

TABLE 3
Apparent Viscosity (Pascal seconds)as function of Shear Rate &
Temperature

| Apparent | | | | | | | | |
|---|---|---|---|---|---|---|---|---|
| Shear | Comparative Example 1 | | | | Example 5 | | | |
| Rate (s⁻¹) | 200° C. | 210° C. | 220° C. | 230° C. | 200° C. | 210° C. | 220° C. | 230° C. |
| 316.2 | 718.5 | 694.6 | 398.4 | 404.7 | 1640.1 | 1545.6 | 1249 | 1005.1 |
| 7.3 | 4958.1 | 3401.7 | 3109 | 2518.9 | 6839.3 | 8959.6 | 7429.2 | 5850.9 |
| 12.2 | 3692.3 | 2601.8 | 2478 | 1913.1 | 5988 | 6820.2 | 5366.2 | 4447.9 |
| 24.3 | 2501.4 | 1903.5 | 1492 | 1377.4 | 4443.2 | 5079.3 | 4022.3 | 3218.8 |
| 36.5 | 2005.6 | 1626.1 | 1043 | 1122.3 | 3854.9 | 4071.7 | 3395.7 | 2652.8 |
| 73 | 1446 | 1120.8 | 757.3 | 795.5 | 2957.3 | 3073.7 | 2448.8 | 1948.2 |
| 97.3 | 1274.6 | 968.5 | 666 | 695.9 | 2762 | 2826.6 | 2249.1 | 1772 |
| 145.9 | 1060.2 | 809.9 | 562 | 576.3 | 2530.1 | 2349.9 | 1878 | 1465.1 |
| 316.2 | 734.3 | 555.9 | 396.2 | 413.9 | 1793.2 | 1573.1 | 1307.5 | 1016.5 |
| 681 | 481.7 | 369.1 | 274.7 | 297 | 1202.3 | 1010.9 | 867.2 | 685.6 |
| 1447.2 | 303 | 215.7 | 184.6 | 193.2 | 686.6 | 642.2 | 541.2 | 433.5 |
| 1994.5 | 247.5 | 179.2 | 156.5 | 164.9 | 493 | 495.6 | ND | 362 |
| 3089 | 185.1 | ND | ND | ND | ND | ND | ND | 255.7 |

Table 4 presents melt tension and flexural modulus data obtained for Comparative Examples 1 and 2 and Example 5. The flexural moduli of the materials were measured according to ASTM D790 on ⅛-inch thick bars that were die-cut from solid plaques formed by compression molding, at 200° C., the pellets produced in the BUSS-KNEADER operation.

The melt tension data were obtained using a GOFFERT RHEOTENS in connection with the KAYENESS GALAXY 5 CAPILLARY RHEOMETER described above. For melt tension testing, the materials were also dried for 18 hours at 50° C. They were then tested for melt strength by extruding a melt strand of the polymer at 220° C. through the 30 L/D capillary die. The strand was extruded through the die using a constant head speed on the capillary rheometer of 6.35 mm/min while the take-up speed of the RHEOTENS equipment was varied from 0 to 120 cm/s.

Average melt tension (a measure of melt strength) data were recorded as the maximum force required to break the molten polymer strand. The maximum draw ratio of the strand was also recorded at this failure point defined as the ratio of the take-up speed to the strand extrusion speed.

TABLE 4
Flexural Modulus, Melt Tension, and Melt Draw Properties

| | Comp. Example 1 | Comp. Example 2 | Example 5 |
|---|---|---|---|
| Flexural Modulus at | 4000 | 38000 | 5000 |
| 23° C. (ASTM D790) | | | |
| (psi) | | | |
| Average Melt | 10.3 | 13.5 | 125.3 |
| Tension of melt at | | | |
| 220° C. (cN) | | | |
| Maximum Draw of | 162.3 | 83.7 | 22.8 |
| melt at 220° C. (%) | | | |

In addition to increasing viscosity, the incorporation of aluminum cations greatly increases the melt tension of the molten material. The data in Table 4 show that the material of Example 5 has over 10 times the melt strength of the material of the control, Comparative Example 1 (125.3 cN versus 10.3 cN).

### Comparative Example 6 and Example 7

Table 5 presents composition information for Comparative Example 6 and Example 7, both of which are based on lonomer C.

Example 7 was prepared by adding the aluminum acetylacetonate to the lonomer C and premixing by tumble mixing the two components in a polyethylene bag. The premixed materials were then added to the feed of a 30 mm co-rotating twin screw extruder with a L/D ratio of 26. Extruder zones from the feed to the die were set at temperatures of 150° C., 220° C., 250° C., 255° C., 260° C., 265° C., 275° C., and 275° C., respectively. The temperature of the die was set at 200° C. The materials were compounded at 8 pounds/hour and 150 RPM. Temperatures of the melt stream exiting the extruder was measured with a handheld thermocouple and were in the range of 300 to 320° C.

TABLE 5

| | Comparative | |
|---|---|---|
| Material | Example 6 | Example 7 |
| Ionomer C (weight %) | 100 | 98 |
| Aluminum Acetylacetonate | 0 | 2 |
| (weight %) | | |
| Calculated % Acid of Ionomer | — | 11% |
| Neutralized by Al⁺³ | | |

TABLE 6
Melt Index, Melt Tension, and Melt Draw Properties

| | Comp. Example 6 | Example 7 |
|---|---|---|
| Melt Index at 190° C. | 0.7 | 0.2 |
| (2.16 kg/190 ° C.) | | |
| Average Melt Tension | 8.0 | 71.7 |
| of melt at 220° C. (cN) | | |
| Maximum Draw of | 188 | 89.6 |
| melt at 220° C. (%) | | |

The ionomers of Comparative Example 6 and Example 7 were used to mold 32 oz. “Boston Round” bottles in extrusion blow molding equipment. A 5-layer BEKUM extrusion blow molding machine using a die with an inner diameter of 15.8 mm and a pin outer diameter of 10.8 mm was used with the feed zone set at 82° C., the first zone set at 193° C., and all other zones set at 204° C. Although this equipment is capable of producing a 5 layer bottle, only single layer bottles were produced for these trials. The monolayer of each material was produced for the blow molded bottles by only using the largest 2 extruders to pump the polymer into the co-extrusion head. In each of the following molding trials below, the die was opened 80% in an effort to mold a bottle with nominal wall thickness of 2 mm.

When the ionomer of Comparative Example 6 was fed to the machine under these conditions, a parison with poor dimensional stability was extruded, with the material drawing down quickly under its own weight. After the mold was closed and an attempt at bottle blowing was completed, a poorly formed bottle was produced with uneven wall thickness ranging from 0.2 to 0.3 mm. A handheld thermocouple probe inserted into the hanging parison recorded a melt temperature of 210° C.

The same equipment conditions were used to mold the aluminum containing ionomer of Example 7. In this case, the large increase in melt strength, evident from the Table 6 data, resulted in a dramatic improvement in the dimensional stability of the hanging parison. This led to blow molded 32 oz bottles with a uniform wall thickness of 2 mm and a total bottle weight of 125 g. A handheld thermocouple probe inserted into the hanging parison recorded a melt temperature of 225° C.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the disclosure.

What is claimed is:

1. An extrusion or injection molded hollow article suitable for use as a preform or parison for blow molding, comprising an ionomer composition that comprises at least one direct or graft copolymer of (a) ethylene, (b) α,β-ethylenically unsaturated carboxylic acid having from 3 to 8 carbon atoms, and (c) softening comonomer selected from the group consisting of vinyl esters of aliphatic carboxylic acids wherein the acids have from 2 to 10 carbon atoms, alkyl vinyl ethers wherein the alkyl group contains from 1 to 10 carbon atoms, and alkyl acrylates or methacrylates wherein the alkyl group contains from 1 to 10 carbon atoms;
wherein the unsaturated carboxylic acid content is from about 1 to about 25 weight percent, the softening comonomer content is from 0 to about 60 weight percent; the remainder being ethylene, such that the ethylene content is greater than about 30 weight percent;
further wherein the acid groups derived from the α,β-ethylenically unsaturated carboxylic acid are about 3 to about 80% neutralized with trivalent cations and from 0 to about 70% neutralized with mono- or divalent cations.

2. The extrusion or injection molded hollow article of claim 1 that is a multilayer hollow article wherein at least one layer comprises the ionomer composition.

3. The extrusion or injection molded hollow article of claim 1 wherein the ionomer composition is about 3 to about 80% neutralized with trivalent cations and from about 1 to about 70% neutralized with mono- or divalent cations.

4. The extrusion or injection molded hollow article of claim 1 wherein from about 20 to about 80% of the acid groups derived from the α,β-ethylenically unsaturated carboxylic acid are neutralized by the total of trivalent, monovalent and divalent cations.

5. The extrusion or injection molded hollow article of claim 1 wherein the melt strength of the ionomer composition is substantially greater than that of an ionomer composition containing the same copolymer but neutralized only with mono- or divalent cations.

6. The extrusion or injection molded hollow article of claim 1 wherein the melt strength of the ionomer composition is greater than about 20 cN when measured at 220° C.

7. A blow molded bottle comprising an ionomer composition that comprises at least one direct or graft copolymer of (a) ethylene, (b) α,β-ethylenically unsaturated carboxylic acid having from 3 to 8 carbon atoms, and (c) softening comonomer selected from the group consisting of vinyl esters of aliphatic carboxylic acids wherein the acids have from 2 to 10 carbon atoms, alkyl vinyl ethers wherein the alkyl group contains from 1 to 10 carbon atoms, and alkyl acrylates or methacrylates wherein the alkyl group contains from 1 to 10 carbon atoms;
wherein the unsaturated carboxylic acid content is from about 1 to about 25 weight percent, the softening comonomer content is from 0 to about 60 weight percent; the remainder being ethylene, such that the ethylene content is greater than about 30 weight percent;
further wherein the acid groups derived from the α,β-ethylenically unsaturated carboxylic acid are about 3 to about 80% neutralized with trivalent cations and from 0 to about 70% neutralized with mono- or divalent cations.

8. The blow molded bottle of claim 7 wherein the ionomer composition is about 3 to about 80% neutralized with trivalent cations and from about 1 to about 70% neutralized with mono- or divalent cations.

9. The blow molded bottle of claim 7 wherein from about 20 to about 80% of the acid groups derived from the α,β-ethylenically unsaturated carboxylic acid are neutralized by the total of trivalent, monovalent and divalent cations.

10. The blow molded bottle of claim 7 wherein the melt strength of the ionomer composition is substantially greater than that of an ionomer composition containing the same copolymer but neutralized only with mono- or divalent cations.

11. The blow molded bottle of claim 7 wherein the melt strength of the ionomer composition is greater than about 20 cN when measured at 220° C.

12. The blow molded bottle of claim 7 wherein the ionomer composition is blended with at least one thermoplastic polymer selected from the group consisting of styrene-butadiene-styrene block copolymer, styrene-ethylene-butylene-styrene block copolymer, styrene-isoprene-styrene block copolymers, linear low density polyethylene, low density polyethylene, polypropylene and cyclic olefin copolymers.

13. A multilayer blow molded bottle wherein the walls of the bottle comprise at least one layer that comprises at least one direct or graft copolymer of (a) ethylene, (b) α,β-ethylenically unsaturated carboxylic acid having from 3 to 8 carbon atoms, and (c) softening comonomer selected from the group consisting of vinyl esters of aliphatic carboxylic acids wherein the acids have from 2 to 10 carbon atoms, alkyl vinyl ethers wherein the alkyl group contains from 1 to 10 carbon atoms, and alkyl acrylates or methacrylates wherein the alkyl group contains from 1 to 10 carbon atoms;
wherein the unsaturated carboxylic acid content is from about 1 to about 25 weight percent, the softening comonomer content is from 0 to about 60 weight percent; the remainder being ethylene, such that the ethylene content is greater than about 30 weight percent;
further wherein the acid groups derived from the α,β-ethylenically unsaturated carboxylic acid are about 3 to about 80% neutralized with trivalent cations and from 0 to about 70% neutralized with mono- or divalent cations; and
wherein the walls of the bottle comprise at least one additional layer.

14. The multilayer blow molded bottle of claim 13 wherein the additional layers comprise polymer selected from the group consisting of styrene-butadiene-styrene block copolymer, styrene-ethylene-butylene-styrene block copolymer, styrene-isoprene-styrene block copolymers, linear low density polyethylene, low density polyethylene, polypropylene and cyclic olefin copolymers.

15. The multilayer blow molded bottle of claim 13 wherein the ionomer composition is about 3 to about 80% neutralized with trivalent cations and from about 1 to about 70% neutralized with mono- or divalent cations.

16. The multilayer blow molded bottle of claim 13 wherein from about 20 to about 80% of the acid groups derived from the α,β-ethylenically unsaturated carboxylic acid are neutralized by the total of trivalent, monovalent and divalent cations.

17. The multilayer blow molded bottle of claim 13 wherein the melt strength of the ionomer composition is substantially greater than that of an ionomer composition containing the same copolymer but neutralized only with mono- or divalent cations.

18. The multilayer blow molded bottle of claim 13 wherein the melt strength of the ionomer composition is greater than about 20 cN when measured at 220° C.

19. A blow molding process for producing bottles from a polymer composition comprising the steps:
(a) molding a closed-bottom hollow preform from the polymer composition at a temperature above the glass transition and melting temperature ranges of the bulk polymer composition;
(b) maintaining the preform at a blow molding temperature above the glass transition and melting temperature ranges of the bulk polymer composition;
(c) stretching the preform axially in a blow mold by means of a stretch rod; and
(d) simultaneously with the axial stretching, introducing compressed air into the preform so as to biaxially expand the preform outwardly against the walls of the blow mold to assume the desired configuration,
wherein the polymer composition comprises at least one direct or graft copolymer of (i) ethylene, (ii) α,β-ethylenically unsaturated carboxylic acid having from 3 to 8 carbon atoms, and (iii) softening comonomer selected from the group consisting of vinyl esters of aliphatic carboxylic acids wherein the acids have from 2 to 10 carbon atoms, alkyl vinyl ethers wherein the alkyl group contains from 1 to 10 carbon atoms, and alkyl acrylates or methacrylates wherein the alkyl group contains from 1 to 10 carbon atoms;
wherein the unsaturated carboxylic acid content is from about 1 to about 25 weight percent, the softening comonomer content is from 0 to about 60 weight percent; the remainder being ethylene, such that the ethylene content is greater than about 30 weight percent;
further wherein the acid groups derived from the α,β-ethylenically unsaturated carboxylic acid are about 3 to about 80% neutralized with trivalent cations and from 0 to about 70% neutralized with mono- or divalent cations.

20. The process of claim 19 wherein the preform is molded by extrusion molding.

21. The process of claim 19 wherein the preform is molded by injection molding.

22. The process of claim 19 wherein the ionomer composition is about 3 to about 80% neutralized with trivalent cations and from about 1 to about 70% neutralized with mono- or divalent cations.

23. The process of claim 19 wherein from about 20 to about 80% of the acid groups derived from the α,β-ethylenically unsaturated carboxylic acid are neutralized by the total of trivalent, monovalent and divalent cations.

24. The process of claim 19 wherein the melt strength of the ionomer composition is substantially greater than that of an ionomer composition containing the same copolymer but neutralized only with mono- or divalent cations.

25. The process of claim 19 wherein the melt strength of the ionomer composition is greater than about 20 cN when measured at 220° C.

26. The process of claim 19 wherein the ionomer composition is blended with at least one thermoplastic polymer selected from the group consisting of styrene-butadiene-styrene block copolymer, styrene-ethylene-butylene-styrene block copolymer, styrene-isoprene-styrene block copolymers, linear low density polyethylene, low density polyethylene, polypropylene and cyclic olefin copolymers.

27. The process of claim 19 wherein the bottles are multilayer polymeric bottles and at least one layer comprises the ionomer composition.
